(19) United States
(12) Patent Application Publication
(10) Pub. No.: US 2002/0147283 A1
(43) Pub. Date: Oct. 10, 2002

(54) PROCESS FOR PREPARING TOUGHENED THERMOSETTING STRUCTURAL MATERIALS

(76) Inventors: SUNG CHUL KIM, SEOUL (KR); YU SEUNG KIM, TAEJON (KR); HYUN SUNG MIN, SEOUL (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/228,358

(22) Filed: Jan. 11, 1999

(30) Foreign Application Priority Data
Oct. 8, 1998 (KR) 98-41980

(51) Int. Cl. C08L 63/00

(52) U.S. Cl. 525/423

(57) ABSTRACT

The present invention relates to a process for preparing toughened thermosetting structural materials, more specifically, to a process for preparing toughened thermosetting materials having a morphology spectrum by regulating the rate of cure reaction of a thermosetting resin and the rate of dissolving a thermoplastic toughening agent in the thermosetting resin to form a morphology spectrum depending on the concentration gradient of the toughening agent, and toughened thermosetting structural materials prepared by the said process. In accordance with the present invention, the thermosetting materials with enhanced toughness and mechanical properties such as chemicals-resistance and heat-resistance, can be prepared by adding a soluble thermoplastic toughening agent in the thermosetting resin in a concentration of less than 20% by weight.

### FIELD OF THE INVENTION

The present invention relates to a process for preparing toughened thermosetting structural materials, more specifically, to a process for preparing toughened thermosetting materials having a morphology spectrum by regulating the rate of cure reaction of a thermosetting resin and the rate of dissolving a thermoplastic toughening agent in the thermosetting resin to form a morphology spectrum depending on the concentration gradient of the toughening agent, and toughened thermosetting structural materials prepared by the said process.

### BACKGROUND OF THE INVENTION

Thermosetting materials such as the epoxy resins, the bismaleimides and the cyanates are currently used for many applications which require a high modulus and strength, a low creep, and a good performance at elevated temperatures. The widespread use of the thermosets, however, is limited in many high-performance applications because of their inherent brittleness.

In this connection, several methods have been proposed to improve on the fracture toughness of the thermosetting networks. The most common method involves the incorporation of a second polymeric component such as functionalized liquid rubber, or high performance engineering thermoplastics.

Traditional liquid rubbers including carboxyl- or amine-terminated copolymers of butadiene and acrylonitrile that are soluble in thermosetting resins have been successful in toughening a number of thermosetting resins, particularly epoxy resin. Examples of such systems are given in Riew, Rubber-Toughened Plastics, Advances in Chemistry 222; American Chemical Society: Washington, D.C.(1989).

Particulate elastomer was also employed in the thermosetting system In U.S. Pat. No. 5,464,902, brittle epoxy resin systems are toughened against impact-induced damage by the addition of minor quantities of functionalized elastomer particles having a particle size of from about 2 μm to about 70 μm. The system exhibits greater toughness as measured by compression strength after impact (“CAI”) when laid up into a quasiisotropic panel employing carbon fiber reinforcement and cured, as compared to epoxy resin without the particulate elastomer.

In high-T_{g} brittle thermosetting system, however, rubber modification is ineffective for toughening because the molecular mobility in the highly cross-linked thermoset is so restricted, the plastic deformations are not possible. Besides, the addition of the rubbery phase reduces the thermal and mechanical properties of the thermoset matrix.

To overcome the reduction of the thermal and mechanical properties, high performance thermoplastics with high T_{g} and modulus have been used as a second component. Initial reports in the literature concerning the use of thermoplastics to toughen epoxy resins appeared in the early 1980s. Bucknall and Partridge employed commercial poly(ethersulfone) as a toughening agent in epoxy resins, Polymer, 30, 213(1983). The fracture toughness measured as stress intensity factor, K_{IC}, showed an increase from 0.6 MPa.m^{½} in epoxy resin to 0.9 MPa.m^{½} in 16 wt % poly(ethersulfone) modified epoxy resins.

In U.S. Pat. Nos. 4,656,207, 4,656,208, and 4,822,832, Chu et al. reported similar results utilizing amino-functionalized thermoplastics. Specifically, they demonstrated that amine-terminated aromatic polyethers, polysulfones, and poly(ethersulfone) of molecular weights in the range of 2,000-10,000 g/mol and T_{g}s between 125 and 250° C. produced multiphase morphologies and significant enhancements in the fracture toughness over the neat resin and the corresponding carbon fiber composites.

In U.S. Pat. No. 5,605,745, particulate amorphous thermoplastic having a mean particle size of from2 μm to 35 μm was incorporated into the epoxy resin and a prepreg comprising carbon fiber reinforcement. Examples of thermoplastics are polysulfone, poly(ethersulfone), polyimide. The CAI results demonstrated that the fracture toughness of the particulate polysulfone modified epoxy increased by about 49% when the concentration of polysulfone increased. In the system, the phase separation was not observed.

Stiff, tough thermoset blends based on dicyanate resins are described in U.S. Pat. Nos. 4,902,752 and 5,548,034. Polysulfone, poly(etherimide) were incorporated with the dicyanate resin or the fluorine-containing cyanate/poly(arylene ether) resin. The resulting cured composition had fracture toughness (G_{IC}) increased from 3 to 6 in-lbs/in².

The fracture toughness of the toughened thermosetting materials is usually dependent upon the morphological features, which is determined mainly with the concentration of the thermoplastic toughening agent. At low thermoplastic contents, typically below 15%, thermoplastic-rich phase segregates into spherical domains within thermoset matrix, which is called sea-island morphology. It results a moderate increase in fracture toughness. Above 15%, a nodular spinodal structure where a thermoset-rich phase forms spherical nodules in a thermoplastic matrix gives a substantial increase in fracture toughness.

Mackinnon, A. J. et al. disclosed the correlation between fracture toughness and thermoplastic modifier concentration, and demonstrated that the fracture toughness increased significantly at about 20% of incorporated poly(ethersulfone), coincident with the occurrence of the nodular spinodal structure, Macromolecules, 25, 3492 (1992) .

Recker et al. proposed that an optimum morphology exist at the thermoplastic composition of 25% for maximum fracture toughness, SAMPE Quart, 21, 46, (1989), They observed that the optimum morphology consists of large epoxy domains of about 100 μm in diameter with small thermoplastic inclusions.

### SUMMARY OF THE INVENTION

In accordance with the present invention, the inventors discovered that: the nodular spinodal structure that developed in high concentration of thermoplastic, usually more than 15%, is advantageous to enhancing toughness; and, the concentration variation of thermoplastic may result in forming a “morphology spectrum”, ranging from the sea-island morphology, to the nodular/sea-island coexisting morphology, to the nodular structure, to the inverted sea-island morphology, and to the homogeneous phase when the overall concentration of thermoplastic toughening agent was less than 20%. The morphology spectrum concept may be utilized effectively to toughen thermosetting materials with low thermoplastic content by adding a soluble thermoplastic material in the thermosetting resin, and regulating the rate of cure reaction and the rate of dissolution of the thermoplastic.

A primary object of the present invention is, therefore, to provide a process for preparing a toughened thermosetting structural materials having a morphology spectrum.

The other object of the invention is to provide toughened thermosetting materials with a morphology spectrum which is prepared by the said process.

### BRIEF DESCRIPTION OF DRAWINGS

The above and the other objects and features of the present invention will become apparent from the following description given in conjunction with the accompanying drawings, in which:

FIG. 1 is a schematic diagram depicting the process of preparing a toughened thermosetting material of the present invention.

FIG. 2 is an enlarged cross-sectional view of a toughened thermosetting material having a morphology spectrum according to the present invention, which shows the morphologies of sea-island morphology, nodular/sea-island coexisting morphology, nodular structure, inverted sea-island morphology, and homogeneous thermoplastic-rich phase.

FIG. 3 is a perspective view of a specimen of a toughened thermosetting material, which is employed to test toughness.

### DETAILED DESCRIPTION OF THE INVENTION

Toughened thermosetting materials having a morphology spectrum of the present invention are prepared by a process which comprises the steps of:

Step 1: Preparation of thermosetting material

A thermosetting material is obtained by the delivery of a thermoplastic toughening agent into a thermosetting resin composition in a quantity of 1% to 20% by weight, more preferably 1% to 15%, based on the thermosetting resin, in a form of film having a uniform thickness or in a form of powder having a uniform distribution.

In this connection, the thermosetting resin composition is all kinds of thermosetting resins dissolving a thermoplastic toughening agent, such as epoxy including polyglycidyl ethers of polyfunctional phenols, polyglycidyl ethers of the chlorination or bromination products of polyvalent phenols, polyglycidyl ethers of novolacs, polyepoxy compounds derived from aromatic amine and epichlorohydrin; phenol; dicyanate; unsaturated polyester; and bismaleimide, and mixtures thereof. The thermosetting resin may be used with the conventional curing agents and catalysts. Curing agents are preferably diamines, more preferably, diaminodiphenyl sulfone, diaminophenyl methane, and phenylenediamine. Curing catalysts are preferably transition metal carboxylates, more preferably, zinc, copper, manganese or cobalt carboxylates.

The thermoplastic toughening agent is selected so that it can be dissolved in organic solvents and diffused in monomer or oligomer of the thermosetting resin, which includes a high molecular weight engineering thermoplastic having a high toughness and thermostability such as polyester, polyamide, polyaramid, polyarylate, polycarbonate, poly(estercarbonate), polybenzimidazole, polyimide, poly(etherimide), poly(amideimide), polyether, polyketone, polyetherketone, poly(etherether ketone), poly(etherketone sulfone), polysulfone and poly(ethersulfone), and mixtures thereof, preferably, the thermoplastic toughening agent may be poly(etherimide) or polysulfone.

It is particularly significant in the present invention that: the toughening agent is dissolved and diffused in the resin to form a proper concentration gradient; and, the morphology spectrum must contain nodular structure and/or nodular/sea-island coexisting morphology after cure. When a large quantity of the toughening agent is added in the thermosetting resin, the advantage of the invention is reduced, because the toughened thermosetting material without a concentration gradient has the nodular structure when the overall composition of thermoplastic is high. When the toughening agent is added in a very small quantity, the morphology spectrum within the thermosetting resin cannot be accomplished, because the toughening agent is dissolved and diffused completely within the resin not to have nodular structure. Therefore, the toughening agent is added in a quantity of 1% to 20% by weight, more preferably 1% to 15% by weight, based on the thermosetting resin.

Step 2: Curing of thermosetting material

To prepare toughened thermosetting materials having a morphology spectrum, curing of the thermosetting material obtained as above is carried out under a proper reaction temperature of −10° C. to 400° C., in accordance with the conventionally known curing method of the thermosetting resin: preferably, the curing is performed in a two-consecutive way each of which is carried out at a temperature of 10° C. to 300° C. for 5 to 10 hrs and at a temperature of 200° C. to 250° C. for 30 min to 2 hrs, respectively. In this connection, the curing condition may be modified, considering a dissolving rate of the toughening agent.

In accordance with the present invention, a morphology spectrum is formed in the toughened thermosetting material by regulating the rate of cure reaction of a thermosetting resin and the rate of dissolving a toughening agent in the matrix. To prepare a toughened thermosetting material having a morphology spectrum, careful consideration should be made, on the kind and quantity of catalyst, and reaction temperature, which are critical factors for determining the reaction rate of a thermosetting resin and the time taken to reach gel point as well.

At the early stage of reaching the gel point, the soluble toughening agent located in thermosetting resin is dissolved and diffused, and a proper concentration gradient of the dissolved toughening agent is formed, and a morphology spectrum is formed within the thermosetting material. However, when the reaction rate of a thermosetting resin is very high by the factors of catalyst or reaction temperature, the toughing agent remains in undissolved state or thermoplastic rich homogeneous phase, which results in the formation of separate layers, and the proper concentration gradient cannot be developed. The formation of separate layer may cause interfacial failure of the thermosetting material. Accordingly, the kind and quantity of catalyst, and reaction temperature should be selected properly, depending on the dissolving rate of a toughening agent.

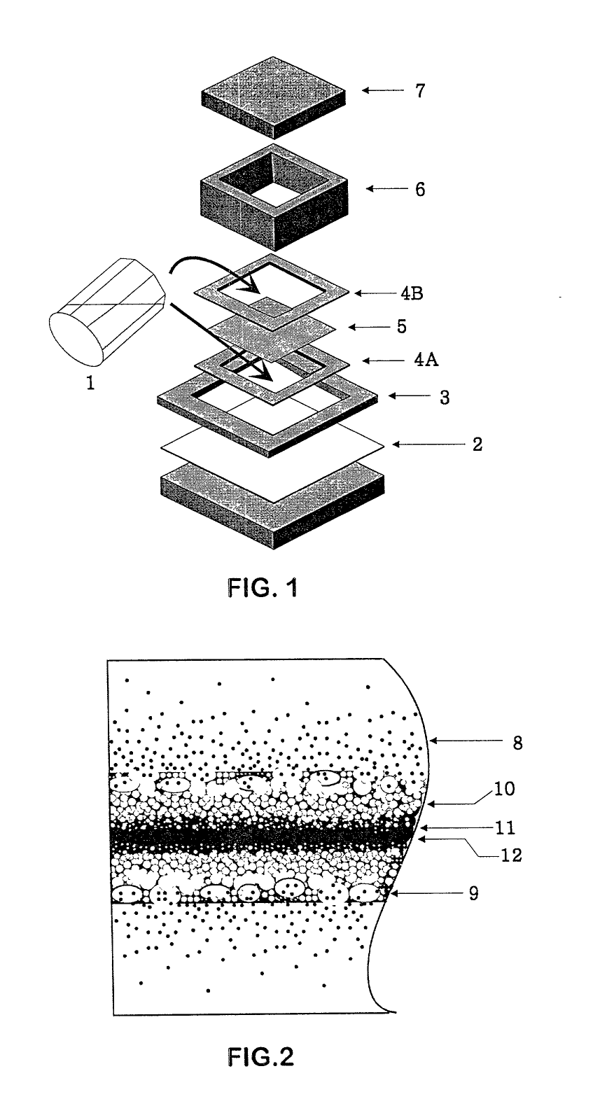

The general process of a thermosetting material having a morphology spectrum according to the present invention is illustrated in the accompanying FIG. 1. As can be seen in FIG. 1, the basic thermosetting material having a morphology spectrum may be produced by delivering a tough and soluble thermoplastic film in the curable thermosetting resin composition. More specifically, the half amount of the thermosetting resin composition 1 is poured in a steel mold 3 onto a releasing film 2. The spacer 4A such as silicone rubber then is located inside the steel mold 3, and the thermoplastic film 5 and the other spacer 4B are covered in order onto the thermosetting resin composition 1. The other half amount of the resin composition 1, is then poured onto the thermoplastic film 5. A pressure weight 6 with a steel lid 7 is used for preventing from the distortion of the spacers at high curing temperature and licking the thermosetting resin composition. Fillers, dyes, pigments, plasticizers, curing catalyst and other such conventional additives may be added to the thermosetting resin composition 1 described herein before curing to influence the properties of the final resin blend.

The morphology spectrum of the present invention is schematically depicted in FIG. 2. Referring to FIG. 2, a morphology spectrum is formed in accordance with the concentration gradient of toughening agent: that is, a sea-island morphology 8 and a coexisting nodular/sea-island morphology 9 are serially formed by low concentration(in less than 15% by weight) of dissolved toughening agent; a nodular structure 10 is formed by a little high concentration(20% to 60% by weight) of dissolved toughening agent; and, either an inverted sea-island morphology 11 where the thermosetting-rich phase forms spherical domains in the thermoplastic-rich phase, or a homogeneous thermoplastic-rich phase 12 where a small amount of thermoset component is mixed homogeneously in thermoplastic phase, is formed by higher concentration(in more than 60% by weight) of dissolved toughening agent.

The nodular spinodal structure is advantageous to enhancing toughness, and the sea-island morphology contributes to the maintenance of mechanical properties over a wide range of temperature and environmental exposures. Therefore, in accordance with the process of the invention, the thermosetting materials with enhanced toughness and mechanical properties such as chemicals-resistance and heat-resistance, is prepared by adding a soluble thermoplastic toughening agent in the curable thermosetting resin in a concentration of less than 20% by weight.

The present invention is further illustrated in the following examples, which should not be taken to limit the scope of the invention

### EXAMPLE 1

### Preparation of toughened thermosetting materials having a morphology spectrum

A thermoplastic toughened agent of polysulfone or poly(etherimide) shown in Table 1 below was first dissolved in a solution of dichloromethane, respectively, to obtain thermoplastic polymer solutions of about 10% by weight. Then, each of the solution thus obtained was poured into a clean glass plate, and films of 0.05 to 0.3 mm in thickness were obtained using a doctor blade, after the remaining solvent was evaporated at 150° C. for 2 hours under a vacuum condition.

Thereafter, toughened thermosetting materials having a morphology spectrum were prepared by delivering the tough and soluble thermoplastic films obtained as above in curable thermosetting resins (see: FIG. 1), where each of the thermoplastic films was applied in amounts between 0.1 to 0.5 grams per square meter, to have a thermoplastic content of 4% to 10% by weight. A sample containing resin A in Table 1 below was cured at 150° C. for 6 hours and post-cured for 90 min in an air-circulated oven maintained at 220° C., and a sample containing resin B in Table 1 below was cured at 210° C. for 9 hours and post-cured at 280° C. for 1 hour, finally to give two kinds of toughened thermosetting materials.

TABLE 1
Compositions of thermosetting resins and
thermoplastic toughening agent

| | Thermoplastic |
|---|---|
| Thermosetting Resin | Toughening Agent |
| Resin A | |
| Diglycidyl ether of bisphenol A | Polysulfone |
| (Kuk Do Chem ® YD 128) | (Amoco ® Udel 1700) |
| Diaminodiphenyl sulfone | |
| (Aldrich Chem. Co.) | |
| Resin B | |
| Bisphenol A dicyanate | poly(etherimide) |
| (Ciba Geigy ® AroCy B10) | (General Electric ® |
| | Ultem 1000) |

Then, it was investigated whether the toughened thermosetting materials thus prepared formed a morphology spectrum as depicted in FIG. 2, and their toughnesses were also measured as mentioned later, whose results were summarized in Tables 2 and 3 below.

The following test procedures were employed in determining stress intensity factor, K_{Ic}, of the cured thermosetting resins produced by the process described as aboves. The cured thermosetting resins having a morphology spectrum were tested by using a single edge notch geometry loaded in three point bending as described ASTM E399-78a.

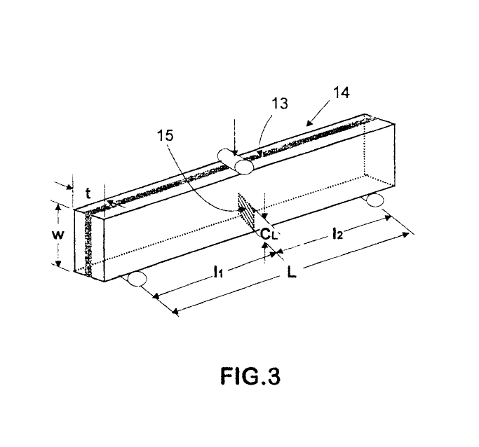

Referring to FIG. 3, a specimen of the toughened thermosetting material is depicted schematically. The morphology spectrum 13 was developed along the direction of specimen depth. In carrying out the test, the resin was cast in the form of a 60 mm×70 mm×3 mm sheet which was then cut to yield a number of rectangular specimens, one of which is shown in FIG. 3 as a specimen 14, where L is 24 mm, w is 6 mm and t is 3 mm. An edge crack 15 was made in each rectangular bar, and special care being taken to insure that the crack plane was perpendicular to the specimens long axis. The crack length C_{L} was in the range of 1.5 mm to 3 mm, distances 1₁ and 1₂ each being 12 mm. Edge crack 14 was made by notching the specimen with a diamond wheel and slicing the specimen with a razor blade. Specifically, a specimen of the above dimensions was clamped and passed over a stationary razor blade. The cracked specimens prepared as discussed above were then loaded in the three point bending fixture as shown in FIG. 3 using an INSTRON® Model 4202 and tested at a crosshead displacement rate of 1 mm/min at a temperature of about 22° C. At critical load, P_{c}, the crack began to propagate and the test was terminated. Seven(sometimes more) tests were made and the sample mean was determined. Mechanical properties of the cured thermosetting resins were also observed, according to the ASTM D638-94b and ASTM 790-84a.

### COMPARATIVE EXAMPLE 1

### Preparation of conventional thermosetting materials

According to the conventional method for solvent blending, two kinds of thermosetting Resin A and Resin B of the same composition as in Example 1, were mixed with a thermoplastic polymer of polysulfone or poly(etherimide), respectively, by dissolving in dichloromethance to obtain a solution of about 35% by weight. Then, the solvent was evaporated at a temperature of 150° C. for 5 hours under a vacuum condition. The resin compositions thus prepared were cured in the same manner as in Example 1. It was investigated whether the thermosetting materials thus prepared form a morphology spectrum, and their toughnesses against crack propagation and mechanical properties were also measured, whose results were summarized in Tables 2 and 3 below.

TABLE 2
Properties of a thermosetting material where
a thersetting resin A is incorporated with a
thermoplastic toughening agent of polysulfone

| | Overall Content of Polysulfone (% by weight) | | | | | |
|---|---|---|---|---|---|---|
| Room | 4 | | 5 | | 6 | |
| Temp. | Comp. | | Comp. | | Comp. | |
| Tests | Ex. 1* | Ex. 1** | Ex. 1* | Ex. 1** | Ex. 1* | Ex. 1** |
| Stress | 1.05 | 1.11 | 1.08 | 1.14 | 1.11 | 1.21 |
| Intensity | | | | | | |
| Factor, K_{IC} | | | | | | |
| (MPa.m^{1/2}) | | | | | | |
| Flexural | 117.3 | 107.8 | 114.2 | 108.6 | 109.6 | 112.6 |
| Strength | | | | | | |
| (MPa) | | | | | | |
| Elastic | 2.15 | 2.08 | 2.13 | 2.15 | 2.13 | 2.19 |
| Modulus | | | | | | |
| (GPa) | | | | | | |
| Formation | No | Yes | No | Yes | No | Yes |
| of | | | | | | |
| Morphology | | | | | | |
| Spectrum | | | | | | |

*: Comparative Example 1
**: Example 1

TABLE 3
Properties of a thermosetting material where
a thermosetting resin B is incorporated with a
thermoplastic toughening agent of poly(etherimide)

| | Overall Content of Poly(etherimide) (% by weight) | | | | | |
|---|---|---|---|---|---|---|
| Room | 5 | | 7.5 | | 10 | |
| Temp. | Comp. | | Comp. | | Comp. | |
| Tests | Ex. 1* | Ex. 1** | Ex. 1* | Ex. 1** | Ex. 1* | Ex. 1** |
| Stress | 0.89 | 1.03 | 0.93 | 1.17 | 0.96 | 1.36 |
| Intensity | | | | | | |
| Factor, K_{IC} | | | | | | |
| (MPa.m^{1/2}) | | | | | | |
| Tensile | 81.8 | 90.8 | 80.2 | 92.0 | 84.3 | 94.9 |
| Strength | | | | | | |
| (MPa) | | | | | | |
| Elastic | 2.58 | 2.63 | 2.59 | 2.64 | 2.59 | 2.68 |
| Modulus | | | | | | |
| (GPa) | | | | | | |
| Elongation | 4.33 | 4.8 | 4.43 | 4.9 | 4.7 | 5.9 |
| at | | | | | | |
| Break (%) | | | | | | |
| Formation | No | Yes | No | Yes | No | Yes |
| of | | | | | | |
| Morphology | | | | | | |
| Spectrum | | | | | | |

*: Comparative Example 1
**: Example 1

As can be seen in Tables 2 and 3, it was found that the thermosetting materials of the invention having a morphology spectrum have a higher mechanical strength and toughness against crack propagation than the conventional ones which do not have a morphology spectrum.

As clearly illustrated and demonstrated as aboves, the present invention provides a process for preparing thermosetting structural materials having a morphology spectrum. In accordance with the present invention, the thermosetting materials with enhanced toughness and mechanical properties such as chemicals-resistance and heat-resistance, can be prepared by adding a soluble thermoplastic toughening agent in the curable thermosetting resin in a concentration of less than 20% by weight.

What is claimed is:

1. A process for preparing thermosetting structural materials having a morphology spectrum which comprises: obtaining a thermosetting material by delivering a soluble toughening agent in a form of film having a uniform thickness or in a form of powder having a uniform distribution into a curable thermosetting resin composition; and, curing the thermosetting material under a reaction temperature of −10° C. to 400° C.

2. The process for preparing thermosetting structural materials having a morphology spectrum of claim 1, wherein the toughening agent is at least one of materials selected from the group consisting of: a high molecular weight thermoplastic having a high toughness and thermostability such as polyester, polyamide, polyaramid, polyacrylate, polycarbonate, poly(estercarbonate), polybenzimidazole, polymide, poly(ethermide), poly(amideimide), polyether, polyketone, poly(etherketone), poly(etherether ketone), polysulfone and poly(ethersulfone), poly(etherketone sulfone), and mixtures thereof.

3. The process for preparing thermosetting structural materials having a morphology spectrum of claim 1, wherein the toughening agent is thermoplastic/thermosetting blends wherein the concentration of the thermosetting component is 1%-20% by weight, based on the weight of the blend.

4. The process for preparing thermosetting structural materials having a morphology spectrum of claim 1, wherein the thermosetting resin composition is a thermosetting resin selected from the group consisting of epoxy, phenol, dicyanate, unsaturated polyester and bismaleimide, which may be used which the conventional curing agents and catalysts, and can dissolve the toughening agent.

5. The process for preparing thermosetting structural materials having a morphology spectrum of claim 4, wherein the epoxy resin composition selected from the group consisting of polyglycidyl ethers of polyfunctional phenols, polyglycidylethers of the chlorination or bromination products of polyvalent phenols, polyglycidyl ethers of novolacs, polyepoxy compounds derived from aromatic amine and epichlorohydrin, and mixtures thereof.

6. The process for preparing thermosetting structural materials having a morphology spectrum of claim 4, wherein the curing agent is diamine.

7. The process for preparing thermosetting structural materials having a morphology spectrum of claim 5, wherein the diamine is selected from the group consisting of diaminodiphenyl sulfone, diaminophenyl methane, and phenyenediamine.

8. The process for preparing thermosetting structural materials having a morphology spectrum of claim 4, wherein the curing catalyst is a transition metal carboxylate.

9. The process for preparing thermosetting structural materials having a morphology spectrum of claim 8, wherein the transition metal carboxylate is selected from the zinc, copper, manganese and cobalt carboxylate.

10. The process for preparing thermosetting structural materials having a morphology spectrum of claim 1, wherein the toughening agent is added in a quantity of 1 to 20% by weight against that of the thermosetting resin.

11. The process for preparing thermosetting structural materials having a morphology spectrum of claim 1, wherein the morphology spectrum is formed by regulating the rate of cure reaction of the thermosetting resin composition and the rate of dissolving the toughening agent dissolved in the resin composition.

12. A thermosetting structural material having a morphology spectrum where sea-island morphology, nodular/sea-island morphology co-presence region, nodular spinodal structure, inverted sea-island morphology, and thermoplastic-rich phase region are formed in order, which is prepared by the process of claim 1.

13. A thermosetting structural material having a morphology spectrum where sea-island morphology, nodular/sea-island morphology coexisting morphology, nodular spinodal structure, and inverted sea-island morphology are formed in order, which is prepared by the process of claim 1.

14. A thermosetting structural material having a morphology spectrum where sea-island morphology, nodular/sea-island morphology coexisting morphology, and nodular spinodal structure are formed in order, which is prepared by the process of claim 1.

15. A thermosetting structural material having a morphology spectrum where sea-island morphology, and nodular/sea-island morphology co-existing morphology are formed in order, which is prepared by the process of claim 1.
